(19) United States
(12) Patent Application Publication
(10) Pub. No.: US 2023/0102567 A1
(43) Pub. Date: Mar. 30, 2023

(54) Battery Receptacle

(71) Applicant: Frank Mikowychok, Lincoln, CA (US)

(72) Inventor: Frank Mikowychok, Lincoln, CA (US)

(21) Appl. No.: 17/490,548

(22) Filed: Sep. 30, 2021

(51) Int. Cl. H01R 9/26; H01M 50/204; H01M 50/296; H01M 50/547

(52) U.S. Cl. CPC H01R 9/2608; H01M 50/204; H01M 50/296; H01M 50/547

(57) ABSTRACT

A battery receptacle system for a rail-style battery pack that is useful for vibrating tools and devices includes multiple resilient members anchored in grooves of the battery receptacle's base. The grooves are positioned below arms that extend from the receptacle's opposing lateral walls. Between each arm and groove, a rail recess accepts rails on a cooperating rail-style battery pack. The resilient members are configured to extend into the rail recess and provide support and resistance against the battery pack's rails when it is engaged with the battery receptacle. The resilient members counteract any excess force and rapid movement caused by the vibrations of the power tool or device coupled to the battery receptacle and battery pack.

### FIELD OF THE INVENTION

The present invention relates to cordless power tools and devices that use battery packs, and more particularly, an improved receptacle for battery packs.

### BACKGROUND OF THE INVENTION

Cordless power devices are useful in the concrete industry especially with respect to concrete finishing tools, such as floats, jointers, screeds, and the like. Concrete finishing tools provide a particular finished surface adjusted to a freshly poured concrete mass. In the conventional method of use of such concrete finishing tools, an operator moves the tool across the surface of the freshly poured concrete, usually in a back-and-forth manner, before the concrete mass cures or dries. Cordless concrete finishing tools use vibratory action to aid in the creation of a surface, characteristic, such as a smooth surface and in the case of a jointer, possesses a groove to control cracking of the finish concrete slab.

Vibration devices for concrete finishing tools include those where an external motor is mounted to a handle or shaft and linked to a remote vibration mechanism by the use of a cable or gear mechanism and where a power source is placed within the handle of the concrete finishing tool and provides power to vibrators that are located atop of the head of the finishing tool adjacent the concrete. Additionally, some concrete finishing tools include a vibrator that is placed within the handle structure of the tools and powered by a battery that is also found in the handle. Other vibration devices employ a vibrator mechanism between the handle and terminus of the concrete finishing tool and allows for optimum vibration of the vibrator mechanism and to automatically assist the operator in propelling the concrete finishing tool forward and backward.

For many cordless concrete finishing tools like other cordless tools and devices, a removable and often rechargeable battery pack supplies power to the tool via a battery receptacle. For some tools, the battery pack is a rail-style battery pack that slides into a rail-style battery receptacle. The rail-style interface system between the battery pack and receptacle is desirable for its advantages over a tower-style interface. For example, a rail-style interface provides separate mechanisms for supporting the weight of the battery back (e.g., rails) and securing the battery pack to the tool (e.g., a latch). Also, the terminal block area of a rail-style battery pack facilitates system expansion as there is space to add additional terminals. The battery cells are contained in the body of the battery pack and there is no need to locate a cell remotely as with a tower-style battery pack. The rail-style battery pack is also simpler to manufacture and more reliable than tower-style systems.

Unfortunately, because of the vibrations imparted by the tool, both rail-style and tower-style battery packs and the battery receptacles are susceptible to failure. When the tool vibrates, excess force and rapid movement causes repeated stress on the battery pack, the battery receptacle, and points of connection between the battery pack and receptacle. Accordingly, it would be desirable to provide a battery receptacle that includes features to reduce stress at the interface between the battery pack and battery receptacle when used with cordless concrete finishing tools. Moreover, it would be desirable to provide an improved rail-style battery receptacle for all tools or devices that vibrate to accommodate rail-style battery packs. Such a receptacle would be a notable advance in the construction arts.

### SUMMARY OF THE INVENTION

In accordance with the present invention several embodiments of a novel and useful resilient rail-style battery interface system for vibrating tools and devices are herein provided. The battery interface system provides features to counteract any excess force and rapid movement caused by the vibrations of the power tool or device coupled to an improved battery receptacle that can receive removable and optionally rechargeable battery packs. The battery receptacle includes a base supporting two opposing lateral side walls and a third wall disposed between them. At one end of the base there is an opening and at the other end, near the third wall and between the lateral side walls, there is a terminal block that includes a terminal face from which contacts extend. The base also defines a groove along a portion of each side wall, and each side wall includes an arm that extends inward above the groove in the base. The area along each side wall that is under the arm and above the groove is a rail recess that receives cooperating rails on a battery pack. Positioned partly within each groove is a resilient member that provides resistance by imparting force against the battery pack rails when the battery pack rails are positioned in the battery receptacle rail recesses. In some embodiments, the grooves may be slots and an adapter plate may be used under the battery receptacle to provide a stable surface for mounting the battery receptacle to irregular and non-planar surfaces and to provide resistance for the resilient member. The battery receptacle also preferably includes additional features common to battery receptacles such as structures or openings to facilitate fastening the battery receptacle to a tool or device, leads couple to the contacts in the battery receptacle and to the power tool for establishing an electrical connection, latch recesses or members to lock a cooperating battery pack in place, and protection circuits.

Operationally, the battery receptacle receives and holds a battery pack when a source of battery power is needed to operate the power tool or device coupled to the battery receptacle. When the rails on a battery pack are fully inserted into the rail recesses of the battery receptacle, contacts of the battery pack couple with the contacts on the battery receptacle to supply power to the attached power tool or device. At that time, each resilient member applies additional support for the battery pack rails and presses the rails against the arms on the battery receptacle to act as a snubber to counteract any excess force or rapid movement caused by the power tool or device.

### BRIEF DESCRIPTION OF THE DRAWINGS

FIG. 1 is a perspective view of a battery receptacle according to the present invention and a cooperating battery pack.

FIG. 2A is a top perspective view of a battery receptacle according to the present invention.

FIG. 2B is a bottom perspective view of the battery receptacle of FIG. 1 and according to the present invention.

FIG. 2C is an illustration of the cooperation of battery receptacle rail recess and battery pack rail according to the present invention.

FIG. 3 is a top perspective view of an alternative embodiment of the battery receptacle according to the present invention.

FIG. 4 is a perspective view of a battery pack that cooperates with the battery receptacle shown in FIG. 3.

FIG. 5 is a side view of a preferred embodiment of the resilient member of the battery receptacle according to the present invention.

FIG. 6 is a top view of the preferred embodiment of the resilient member of the battery receptacle according to the present invention.

FIG. 7 is a top view of the preferred embodiment of the battery receptacle according to the present invention.

FIG. 8 is a bottom view of the preferred embodiment of the battery receptacle according to the present invention.

FIG. 9A is a cutaway view of the preferred embodiment of the battery receptacle shown in FIG. 7 as cut along the line 9A-9A.

FIG. 9B an illustration of the cooperation of battery receptacle rail recess and battery pack rail according to the preferred embodiment of the present invention.

FIG. 10 is a side partial elevational view of a concrete finishing tool with an automatic vibration imparting assembly using an embodiment of the battery receptacle of the present invention installed therein.

FIG. 11 is a top view of the automatic vibration imparting assembly of FIG. 7 with the battery receptacle of the present invention installed therein.

FIG. 12 is an elevational view of a concrete finishing tool with an inline automatic vibration imparting assembly with the battery receptacle of the present invention installed thereon with an adapter plate.

FIG. 13 is an illustration of an inline automatic vibration imparting assembly with a non-planar surface to which an adapter plate can be attached.

FIG. 14 is first perspective view of a preferred embodiment of an adapter plate of the present invention.

FIG. 15 is a second perspective view of the preferred embodiment of an adapter plate of the present invention.

FIG. 16 is an end view of the adapter plate shown in FIGS. 14 and 15 attached to the inline automatic vibration imparting assembly of FIG. 13.

For a better understanding of the invention reference is made to the following detailed description of the preferred embodiments of the invention which should be taken in conjunction with the above described drawings.

### DETAILED DESCRIPTION OF THE INVENTION

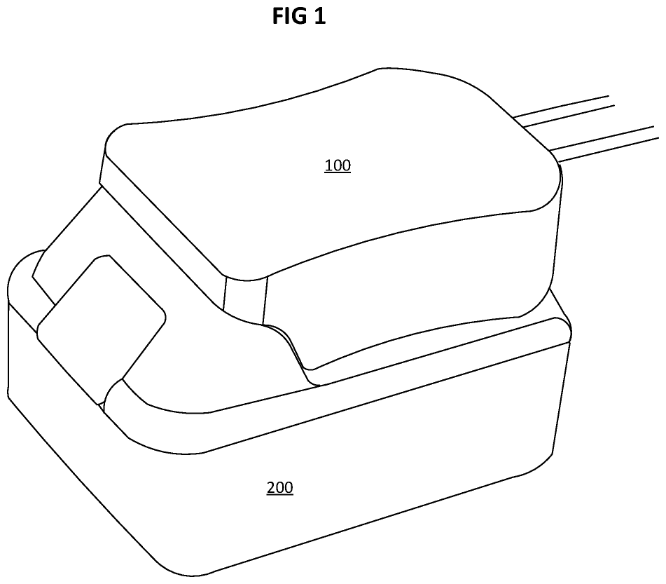

Various aspects of the present invention will evolve from the following detailed description of the preferred embodiments thereof which should be referenced to the prior described drawings. FIGS. 1-16 illustrate embodiments and applications of a battery receptacle that cooperates with a removable and rechargeable battery pack.

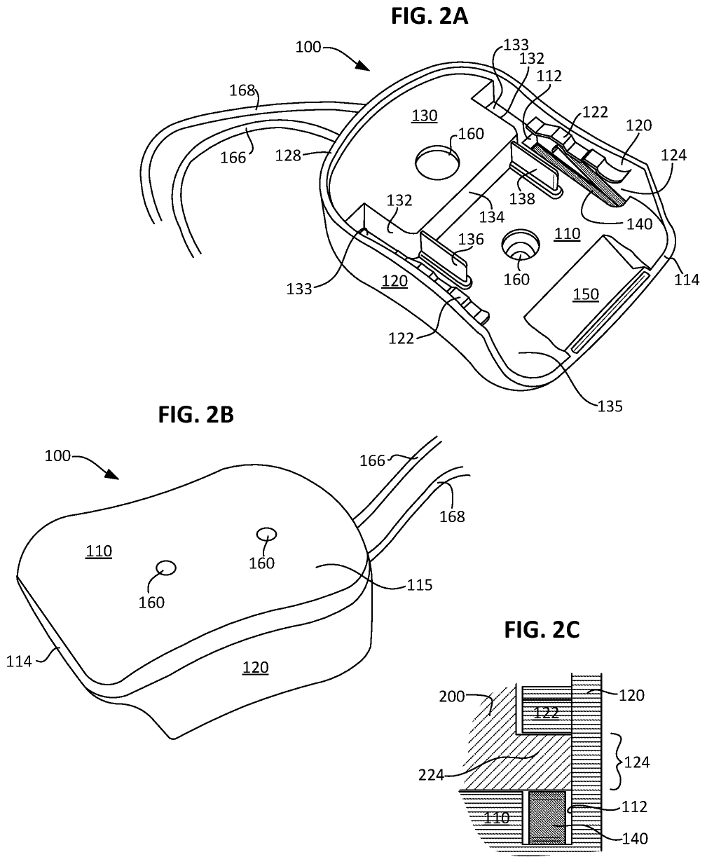

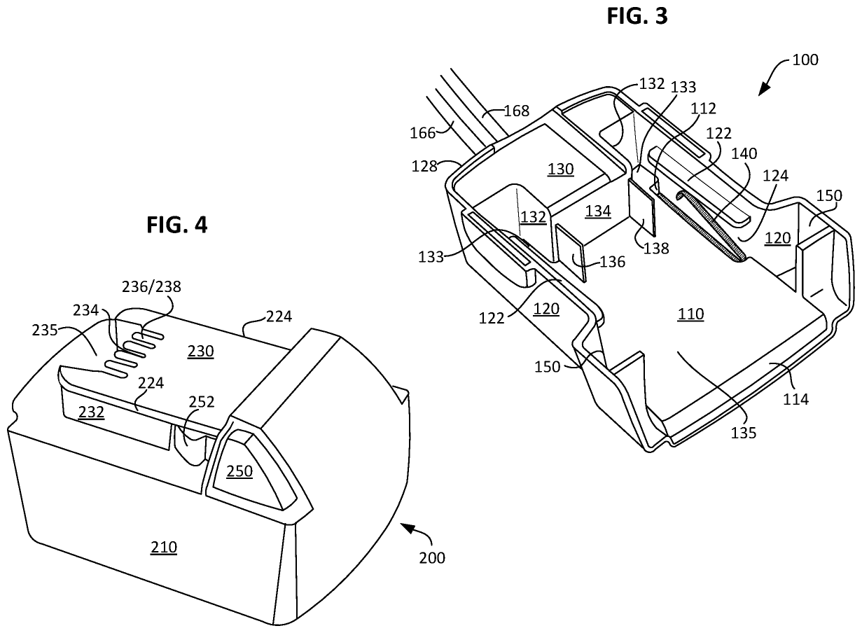

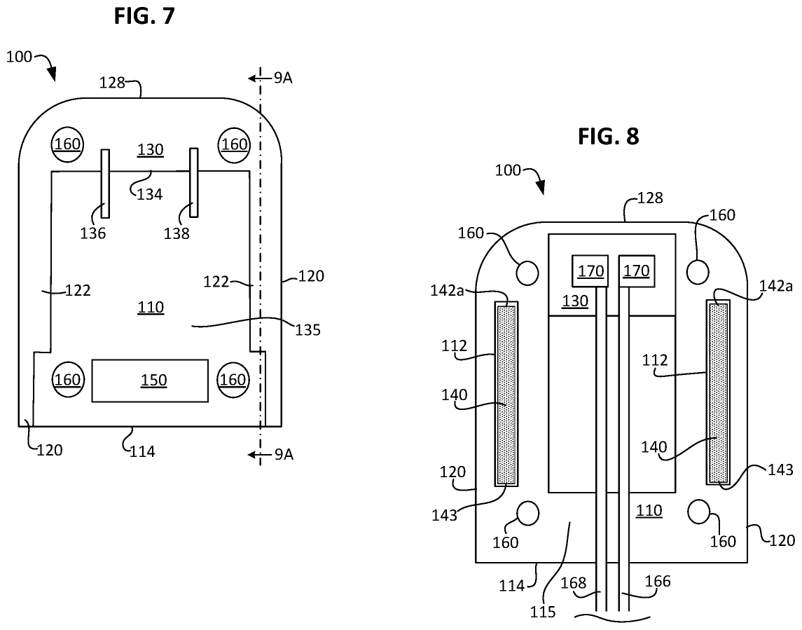

FIG. 1 illustrates an exemplary improved battery receptacle 100 as attached to an exemplary battery pack 200, FIGS. 2A-2B illustrate the features of the exemplary battery receptacle 100, FIG. 3 illustrates the features of an alternate embodiment of battery receptacle 100, and FIGS. 7-9 illustrate the features of a third embodiment of battery receptacle 100. As shown in FIGS. 2A-2B, 3, and 7-9 battery receptacle 100 includes a base 110 that has a lower surface or underside 115, is open at a first end 114, supports two opposing lateral side walls 120 extending therefrom, and supports a third wall 128 disposed between and connecting lateral side walls 120. The third wall preferably is integrally connected with the lateral side walls 120, all of which is preferably integrally connect to base 110 and made from engineered plastic such as ABS plastic, another thermoplastic polymer, a high performance acetal resin such as Delrin® from DuPont of Wilmington, Del., or another thermoplastic resin polymer.

Base 110 also supports a receptacle terminal block 130 that is preferably positioned between a portion of lateral side walls 120, at a distance for the base open end 114, and near the third wall 128. Receptacle terminal block 130 houses, supports, or accommodates any needed circuitry and electrical connections and is preferably integrally connected to base 110. Receptacle terminal block 130 includes a terminal end 130 defined by two opposite lateral terminal side walls 132 and a terminal face 134 extending generally perpendicular to and between the two opposite lateral terminal side walls 132. A terminal block recess 133 may be present if terminal block sidewalls 132 sit at a spaced distance from side walls 120 as shown in FIGS. 2A and 3. Terminal block recess 133 is in fluid communication with a receptacle recess 135, which is defined by the terminal face 134 and receptacle opposing side walls 120. Where no recess 133 is present as shown in FIG. 7, terminal side walls 132 are a portion of receptacle side walls 120.

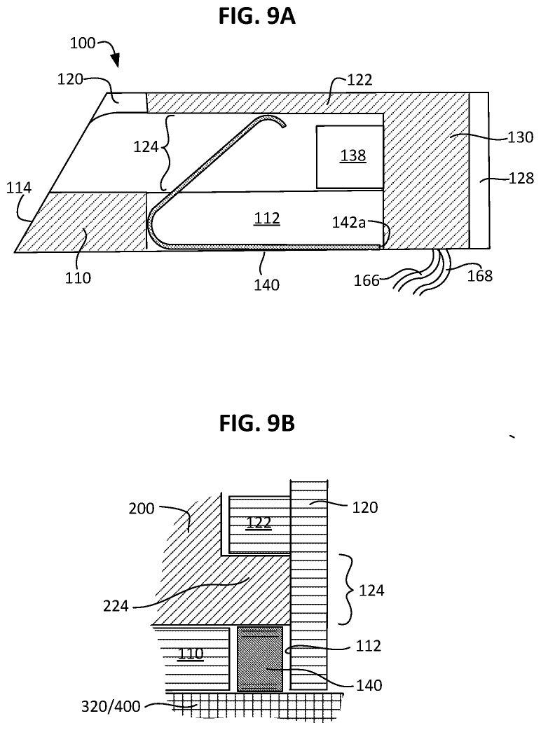

Extending from the terminal face 134 toward the first end 114 of base 110 near terminal side walls 132 are positive and negative contacts 136 and 138. For example, a positive contact 136 can extend from terminal face 134 near one lateral terminal side walls 132, and a negative contact 138 can extend from terminal face 134 near the opposite lateral terminal side wall 132. Additional contacts can be included depending on the cooperating battery pack, as will be understood by those skilled in the art. The positive and negative contacts 136 and 138 are configured to receive contacts on a cooperating battery pack 200 to provide electrical connection therebetween. The contacts 136 and 138 are further coupled to positive and negative leads 166 and 168 within or at the terminal block 130, and the positive and negative terminal 166 and 168 leads exit terminal block 130 through third wall 128 as shown in FIGS. 2A-2B and 3 or through the underside of base 110 as shown in FIGS. 8 and 9 so that they can couple to and cooperate with the tool or device needing power to electrically connect with and communicate with the battery pack 200. Leads 166 and 168 are preferably made insulated copper conductor surrounded by electrical insulation as is known in the art. Where leads 166 and 168 exit receptacle 100, preferably a waterproof seal 170 is present to prevent moisture from entering the terminal block 130 and to protect the internal wiring. For example, a butyl rubber tape or putty for waterproofing can be applied at and around the exit location as shown in FIG. 8.

Base 110 also preferably includes a pair of opposing lateral grooves 112 adjacent to and along a portion of side walls 120 as shown in FIGS. 2A, 3, and 8. Grooves 112 may extend partially into base 110 as shown in FIGS. 2A-3, or grooves 112 may be slots or openings that fully extend through base 110 as shown in FIGS. 7-9B. Along substantially the same portion of side walls 120 as lateral grooves 112 and at a spaced distance from base 110, a pair of arms 122 extend inward as shown. Arms 122 preferably are integrally connected to side walls 120 and are configured to cooperate with the shape and size of corresponding rails 224 on a cooperating battery pack 200. Immediately above grooves 112, arms 110 provide an inwardly directed rail recess 124 extending along two opposite lateral sides 120. The rail recesses 124 also are configured to cooperate with the corresponding rails 224 of a cooperating battery pack 200. FIG. 4 illustrates an exemplary rail 224 on a battery pack 200 that cooperates with a corresponding rail recess 124 shown in FIG. 3.

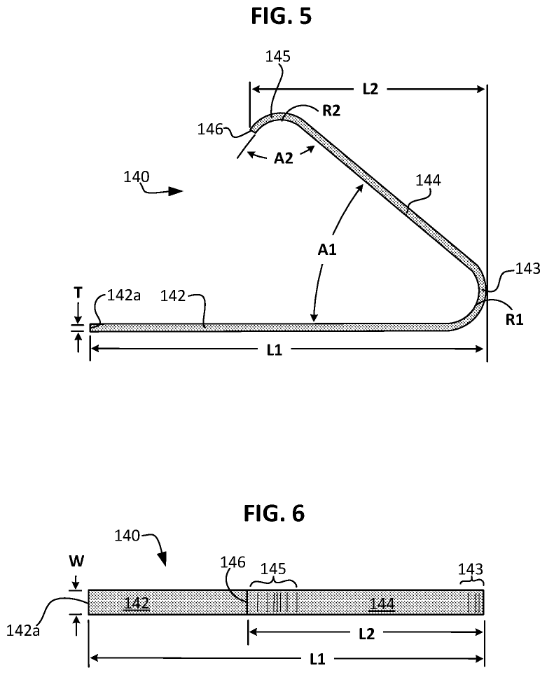

Partially disposed in or through each groove 112 of battery receptacle 100 is a resilient member 140 that acts as a snubber to combat excess force or rapid movement caused by the vibrating of the tool or device when it is operating. FIGS. 5-6 illustrate an embodiment of resilient member 140. Preferably, resilient member 140 is a stainless steel flat spring clip configured as shown in FIGS. 5 and 6. As shown, it has integrally formed sections including a base section 142 with a first end 142a, an angled section 144, an end section 146, a first bend 143 connecting the base section 142 to the angled section 144, and a second bend 145 connecting the angled section 144 to the end section 146. When disposed partly in or through groove 112, base section 142 sits in or just below groove 112 depending on the groove configuration with first end 142 positioned near terminal block 130 and third wall 128 of base 110 and first bend 143 positioned near the open end 114 of base 110. Additionally, the angled section 144 of resilient member 140 extends up into rail recess 124 and optionally second bend 145 of resilient member 140 abuts arm 122 when no battery pack 200 and rail 224 is present.

Preferably, the width W and thickness T of resilient member 140 is substantially consistent across its multiple sections. Thickness T is preferably about 0.031 inches but can be any thickness that provides adequate resistance and support when under pressure and that can be formed into the desired shape. Width W is preferably a width that can be inserted easily in groove 112 and more preferably is between 0.15 and 0.30 inches. More preferably, width W is 0.17 inches or 0.25 inches. The overall length L1 of resilient member 140 is preferably a length that can be inserted easily in groove 112. Preferably, L1 will be approximately the length of groove 112 or smaller. Preferably, length L1 is between 1.0 and 3 inches and more preferably is between 1.68 and 2.02 inches. A second length L2 corresponds to the portion of length L1 that is overlapped by the first and second bend sections 143 and 145 and the angled section 144 as shown in the FIGS. 7 and 8. The overlap length L2 is between 50% and 80% of L1.

First and second bends 143 and 145 of resilient member 140 have a radius of R1 and R2 respectively, where preferably R1 and R2 have the same radius and more preferably it is about 0.19 inches. Radius R1 and R2 can differ and can be larger or smaller than 0.19 inches provided resilient member 140 provides adequate resistance and support when under pressure. The angles A1 and A2 between the base section 142 and angled section 144 and between the angled section 144 and the end section 146, respectively, are likewise preferably equal to one another. As shown in the Figures, A1 and A2 are about 40 degrees. Angles A1 and A2 can differ and can be larger or smaller than 40 degrees provided resilient member 140 continues to provide adequate resistance and support when under pressure. End section 146 is preferably of negligible length so that it does not prevent resilient member 140 from compressing when under pressure but can be longer if desired or if needed to prevent resilient member 140 from excessive compression when under pressure.

The following table includes examples of appropriate dimensions for three different configurations of resilient member 140 as used with a battery receptacle 100 configured to cooperate with a Makita brand rail-style battery (Resilient Member 1), a Milwaukee brand rail-style battery (Resilient Member 2), and a DeWalt brand rail-style battery (Resilient Member 3).

| | | | | | | | A1 | A2 |
|---|---|---|---|---|---|---|---|---|
| Resilient | T | W | L1 | L2 | R1 | R2 | (de- | (de- |
| Member | (in.) | (in.) | (in.) | (in.) | (in.) | (in.) | grees) | grees) |
| 1 | 0.031 | 0.170 | 1.900 | 1.130 | 0.190 | 0.190 | 40 | 40 |
| 2 | 0.031 | 0.250 | 1.680 | 1.200 | 0.190 | 0.190 | 40 | 40 |
| 3 | 0.031 | 0.250 | 2.020 | 1.450 | 0.190 | 0.190 | 40 | 40 |

While a spring clip is shown and described herein as an appropriate configuration of resilient member 140, it is anticipated that resilient member 140 includes any resilient structure that can fit within or through groove 112 to provide resistance against the rail 224 of battery pack 200 when it is positioned in the rail recess 124 of battery receptacle 100. FIG. 2C illustrates one example of how the arm 122 and rail recess 124, groove 112, and resilient member 140, and battery rail 224 cooperate when rail 224 is disposed in rail recess 124. FIG. 9B illustrates the cooperation between arm 122, rail recess 124, groove 112, resilient member 130, and rail 224 when groove 112 is configured as a slot such as with the embodiment shown in FIGS. 7-9A. When groove 112 is a slot, preferably battery receptacle 100 is mounted to a flat surface such as a flat adapter bracket 400 or flat housing 320, which abuts at least part of the underside of base 110 and acts as an anchor for the base section 142 of resilient member 140 such that when downward pressure is applied to resilient member 140, base section 142 remains stationary.

Base 110 further preferably includes features necessary for connecting base 110 to other devices and tools, for cooperating with and securing the battery pack 200, and for protecting or facilitating the electrical connection between the battery pack 200 and receptacle 100 and between the receptacle 100 and the attached power tool or device. For example, base 110 may include mounting hardware extending from base 110 (not shown), or it may define openings configured to accept fasteners. For example, as shown in FIGS. 2A-2B, base 110 and terminal block 130 include two openings 160 for countersunk bolts or screws. More preferably, base 110 and terminal block 130 include four openings 160 positioned near the corners of base 110 as shown in FIGS. 7-8. Additionally, base 110 may define a latch recess 150 configured to cooperate with any latch member 252 and latch release button 250 on a cooperating batter pack 200. FIGS. 2A and 7 illustrates a latch recess defined by base 110. FIG. 3 illustrates an alternate configuration of battery receptacle 100 where two opposing latch recesses 150 are defined by side walls 120 rather than base 110. FIG. 4 illustrates a battery pack for use with the battery receptacle shown in FIG. 3 and includes two latch release buttons 250 that operate two latch members 252, each of which is configured to extend into latch recesses 150 when the battery pack 200 is seated in battery receptacle 100.

Battery receptacle 100 further optionally includes features for protecting or facilitating the electrical connection between the battery pack 200 and receptacle 100 or between the receptacle 100 and the attached power tool or device. For example, battery receptacle 100 may include protection circuits (not shown) housed within the terminal block 130.

An exemplary battery pack is illustrated in FIG. 4 and includes a cell casing 210 made from plastic or another non-conductive material housing multiple battery cells (not shown) and related circuitry (not shown). A battery terminal block 230 with opposing lateral sides 232, a terminal recess 235 disposed between the lateral sides 232, and a terminal face 234 perpendicular to and disposed between lateral sides 232. Positive and negative contacts 236 and 238 extend from terminal face 234 and into terminal recess 235. Contacts 236 are configured to make an electrical connection with the contacts 136 and 138 on battery pack 100 when the battery pack 200 is seated in battery receptacle 100. Additional contacts can be included, and contacts can be any suitable configuration for making an electrical connection, including self-cleaning double contacts, covered contacts, or exposed contacts, as will be known by those skilled in the art.

Along each terminal block lateral side 232 of the battery pack 200, a rail 224 extends outwardly. Rail 224 is configured to cooperate with the rail recess 124 the battery receptacle 100 and portions of rails 224 may extend into the battery receptacle's terminal block recesses 133 when present to allow the battery receptacle terminal block 130 to extend into the battery pack terminal recess 235. FIGS. 2C and 9B illustrate how a rail 224 fits within the rail recess 124 of battery receptacle 100. As shown, resilient member 140 provides additional support by pressing on the rail 224 so that it securely abuts arm 122. When the power tool connected to battery receptacle 100 and battery pack 200 vibrates, resilient member 140 provides additional support to maintain the battery pack securely and appropriately positioned within battery receptacle 100.

Battery pack 200 also includes any necessary attachment and locking means such as a latch system for cooperating with a latch recess 150 on battery receptacle 100. As shown in FIG., 4, the latch system includes a pair of latch release buttons 250 that operate a pair of movable latch members 252 such that when latch release buttons 250 are engaged, latch members 252 withdraw into the battery terminal block 230 so the battery pack 200 can be easily slide on and be positioned in battery receptacle 100. Once the battery pack 200 is fully seated, the latch release buttons cease to be engaged and preferably the latch members 252 engage the latch recesses 150 on battery receptacle 100. To uncouple the battery pack 200 from battery receptacle, the latch release buttons 250 are engaged to withdraw the latch members 252 so that the battery pack can side out. Other latch arrangements can be used to lock battery pack 200 in battery receptacle 100 as will be known to those skilled in the art.

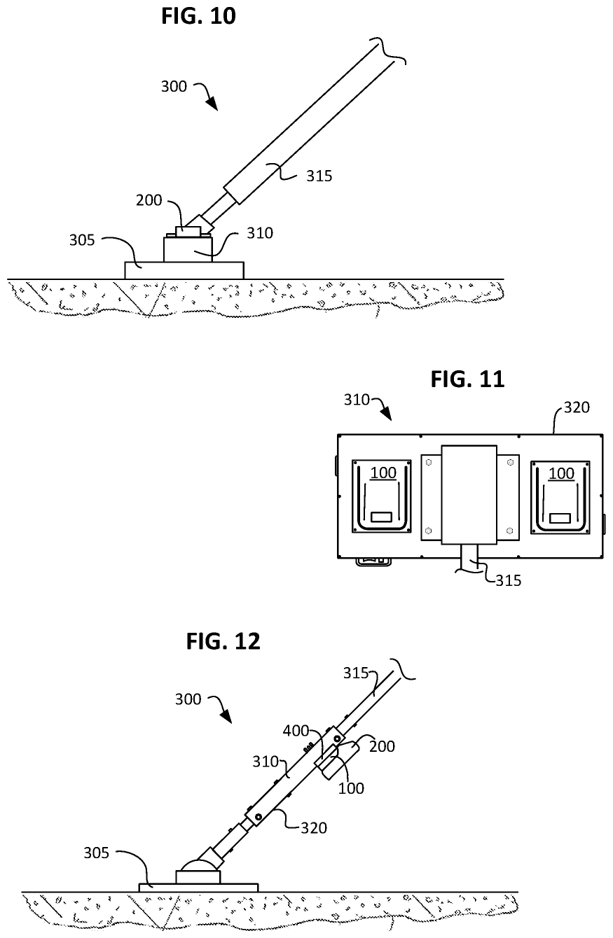

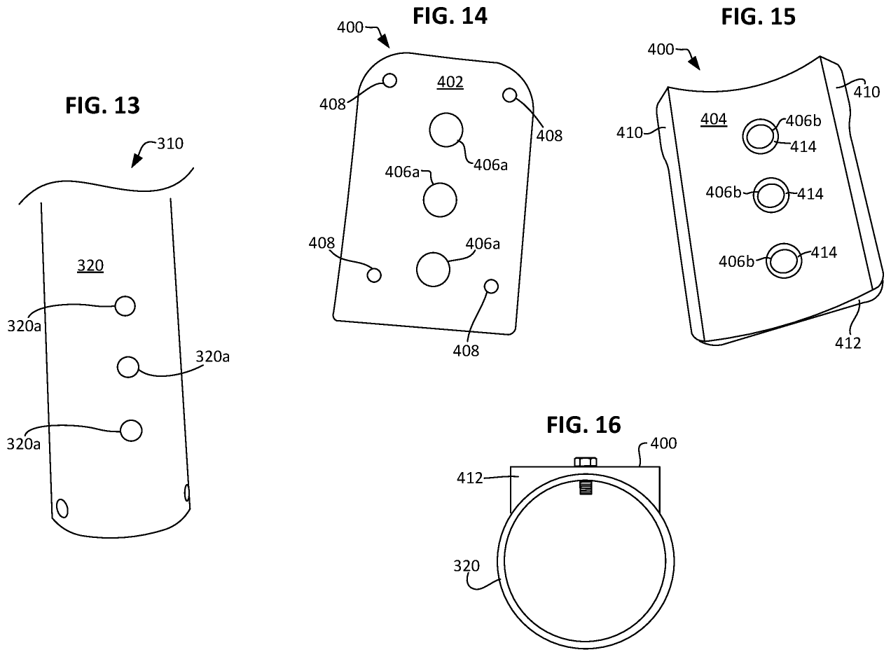

FIGS. 10-12 illustrate a concrete finishing tool 300 having a float 305, handle 315, and an automatic vibrator assembly 310 such as the one described in U.S. Pat. No. 10,968,574, which is incorporated herein by reference. As shown, the automatic vibrator assembly 310 comprises a housing 320 that supports vibrator mechanisms including bidirectional or unidirectional motor and rotor assemblies (not shown) such as the ones described in U.S. Pat. Nos. 10,326,331, 10,184,217, 9,719,215, 9,397,531, and 9,139,966, which are incorporated herein by reference. The housing 320 also houses or supports a battery receptacle 100 for receiving a battery pack 200. Battery receptacle 100 is coupled to the vibrator mechanisms in the housing 320. As shown in FIG. 8, battery receptacles 100 are preferably oriented so that they are substantially equally spaced from the sides of the housing 320 to distribute weight evenly across lid 102. Preferably battery receptacles 100 securely fasten to housing 320 such as with bolts and are in electrical communication with the other components of the finishing tool 300 as needed.

Where housing 320 has a circular or irregular surface or cross-section, such as the inline vibrator mechanism shown in FIGS. 12 and 13, an adapter bracket 400 preferably attaches to the surface of the vibrator mechanism 310 to create a flat mounting surface. FIGS. 14-16 illustrate an exemplary adapter bracket 400 for connecting to a curved surface such as that of the inline vibrator mechanism shown in FIG. 13. Adapter bracket 400 includes a mounting surface 402, a housing surface 404, and openings 406a and 406b for fasteners and wires as will be known to those skilled in the art. Preferably, openings 406a and 406b extend through both the mounting surface 402 and housing surface 404 respectively to create a channel or are aligned to create a pathway to accept fasteners. Openings 406a and 406b also are positioned to cooperate with openings 320a on a vibrator mechanism housing 320 when adapter plate 400 is positioned as desired for attaching it to housing 320. More preferably, openings are sized to accept either fasteners or leads to allow adapter 400 to accommodate a variety of battery receptacle 100 embodiments. Adapter 400 housing surface 404 mirrors the housing 320 to which it will attach, and mounting surface 402 receives battery receptacle 100. Connecting the mounting surface 402 to the housing surface 404 are one or more adapter side walls 410 and 412. Mounting surface 402 also preferably defines openings 408 for receiving the fasteners required to attach battery receptacle 100 to adapter bracket 400. Housing surface 404 may support gaskets or seals such as the O-rings 414 shown in FIG. 15 that enhance and protect the components when battery receptacle 100 and adapter plate 400 are attached to a vibrator mechanism housing 320 or another tool. Housing surface 404 as shown is a curved surface but it is anticipated that it can be any irregular or non-planar surface that cooperates with a complimentary irregular or non-planar surface on a tool to which it attaches, as will be understood by those skilled in the art. When battery receptacle 100 is attached to adapter plate 400, the mounting surface 402 of adapter bracket 400 can serve as an anchor for base section 142 of resilient member 140 such that it resists pressure applied to resilient member 140 and prevents displacement of base section 142 when a rail 224 is present in rail recess 124 of the receptacle embodiment having a slotted version of groove 112 as shown in FIGS. 7-9B.

Operationally, battery receptacle 100 receives and holds battery pack 200 when a source of battery power is needed to operate the power tool or device coupled to battery receptacle 100. To establish a proper connection between battery receptacle 100 and battery pack 200, the rails 224 on battery pack 200 are introduced at the open end 114 of base 110 to the rail recesses 124. Rails 224 are then slid into the rail recesses 124, which applies force to resilient members 140 and causes them to compress. Once the rails 224 are fully inserted into rail recesses 124, the terminal face 134 of battery receptacle block terminal 130 and terminal face 234 of battery pack block terminal 230 should be positioned adjacent to each other and the battery receptacle contacts 136 and 138 couple to the battery pack contacts 238 and 236 to form an electrical connection. Once positioned so, resilient members 140 also apply additional support for rails 224 and press rails 224 against arms 122 on battery receptacle 100. Additionally, any latch members 252 on battery pack 200 become inserted in latch recesses 150 on battery receptacle 100 to lock battery pack 200 in place. When battery pack 200 is positioned correctly in battery receptacle 100 and locked in place, the associated power tool or device becomes coupled to battery pack 200 so that it can operate cordlessly. With the improved design of the battery receptacle, power tools or devices that vibrate benefit from battery receptacle's resilient members 140, which act as a snubber to counteract any excess force or rapid movement caused by the power tool or device. To remove battery pack 200 from receptacle 100, the latch release buttons can be engaged to withdraw the latch members 252 from latch recesses 150, and then battery pack 200 can slide out of rail recesses 113 and battery receptacle 100 at base opening 114.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

I claim:

1. A battery receptacle system for coupling to rail-style battery packs comprises:
a) a base defining first and second lateral grooves;
b) a first lateral side wall connected to the base and extending in a first direction from the base, wherein the first lateral side wall comprises a first inwardly extending arm and wherein the first lateral groove of the base is positioned near the first lateral side wall and substantially aligned with the first arm;
c) a second lateral side wall connected to the base and extending in the first direction from the base, wherein the second lateral side wall comprises a second inwardly extending arm and wherein the second lateral groove of the base is positioned near the second lateral side wall and substantially aligned with the second arm;
d) a terminal block connected to the base and extending in a first direction from the base, wherein the terminal block comprises a terminal face, wherein a receptacle recess is defined by the base, the terminal face, the first lateral side wall and the second lateral side wall;
e) first and second contacts connected to the terminal face of the terminal block and extending into the receptacle recess;
f) a first resilient member disposed in the first groove, wherein the first resilient member comprises a base section configured to fit at least partially within the first groove and an angled section connected to the base section and configured to extend from the receptacle base into the receptacle recess and toward the first arm; and
g) a second resilient member disposed in the second groove, wherein the second resilient member comprises a base section configured to fit at least partially within the second groove and an angled section connected to the base section and configured to extend from the receptacle base into the receptacle recess and toward the second arm.

2. The battery receptacle system of claim 1 wherein first resilient member further comprises a first bend connecting the first resilient member base section to the first resilient member angled section and wherein the second resilient member further comprises a first bend connecting the second resilient member base section to the second resilient member angled section.

3. The battery receptacle system of claim 2 wherein the first resilient member further comprises a first resilient member end section connected to the first resilient member angled section with a second bend and the second resilient member further comprises a second resilient member end section connected to the second resilient member angled section with a second bend.

4. The battery receptacle system of claim 1 wherein the first resilient member comprises stainless steel and wherein the second resilient member comprises stainless steel.

5. The battery receptacle system of claim 2 wherein the overall length first resilient member comprises stainless steel and wherein the second resilient member comprises stainless steel.

6. The battery receptacle system of claim 3 wherein the first resilient member comprises stainless steel and wherein the second resilient member comprises stainless steel.

7. The battery receptacle system of claim 1 wherein the first resilient member overall length is shorter than the length of the first lateral groove and wherein the second resilient member overall length is shorter than the length of the second lateral groove.

8. The battery receptacle system of claim 1 wherein the first and second lateral grooves are slots, wherein the first resilient member overall length is shorter than the length of the first lateral groove, wherein the second resilient member overall length is shorter than the length of the second lateral groove, and wherein the battery receptacle system further comprises an adapter plate secured to the base and positioned to abut the base sections of the first and second resilient members.

9. The battery receptacle system of claim 8 wherein the adapter plate comprises a planar mounting surface for abutting the first and second resilient members, a housing surface configured to cooperate with a non-planar surface on a cooperating tool, and an adapter side wall connecting the mounting surface to the housing surface.

10. The battery receptacle system of claim 1 further comprising a first lead coupled to the first contact and a second lead coupled to the second contact, wherein first and second leads couple to the first and second contacts in the terminal block and exit the terminal block through an opening defined by the base.

11. The battery receptacle system of claim 10 further comprises a waterproof seal surrounding the first and second leads where they exit the terminal block.

12. The battery receptacle system of claim 9 further comprising a first lead coupled to the first contact and a second lead coupled to the second contact, wherein first and second leads couple to the first and second contacts in the terminal block and exit the terminal block through an opening defined by the base and wherein the adapter plate defines an opening sized and positioned to accept the first and second leads.

13. The battery receptacle system of claim 12 wherein the adapter bracket further defines openings to accept fasteners for connecting the adapter bracket to a cooperating tool.

14. A battery receptacle system for coupling to rail-style battery packs comprises:
a) a base comprising an underside and a receptacle recess, wherein the receptacle recess is defined by:
i) a first lateral side wall connected to the base and extending in a first direction from the base;
ii) a second lateral side wall connected to the base and extending in the first direction from the base; and
iii) a face of a terminal block, wherein the terminal block connects to the base and extends in a first direction from the base;
b) a first slot defined by the base and disposed adjacent the first lateral side wall, wherein the underside of the base is in fluid communication with the receptacle recess through the first slot;
c) a second slot defined by the base and disposed adjacent the second lateral side wall, wherein the underside of the base in in fluid communication with the receptacle recess through the second slot;
d) a first arm connected to the first lateral side wall at a spaced distance from the base and extending into the receptacle recess, wherein the first lateral slot and first arm are substantially aligned;
e) a second extending arm connected to the second lateral side wall at a spaced distance from the base and extending into the receptacle recess, wherein the second lateral slot and second arm are substantially aligned;
f) first and second contacts connected to the terminal face of the terminal block and extending into the receptacle recess;
g) a first resilient member disposed through the first slot, wherein the first resilient member comprises a base section configured to fit partially within the first slot and an angled section connected to the base section and configured to extend from the receptacle base into the receptacle recess and toward the first arm; and
h) a second resilient member disposed through the second slot, wherein the second resilient member comprises a base section configured to fit partially within the second slot and an angled section connected to the base section and configured to extend from the receptacle base into the receptacle recess and toward the second arm.

15. The battery receptacle of claim 14 wherein the first resilient member has an overall length that is shorter than the length of the first slot, wherein the second resilient member has an overall length that is shorter than the length of the second slot, and wherein the battery receptacle system further comprises an adapter plate secured to the base and positioned to abut the underside of the base and the base sections of the first and second resilient members.

16. The battery receptacle system of claim 14 wherein first resilient member further comprises a first bend connecting the first resilient member base section to the first resilient member angled section and wherein the second resilient member further comprises a first bend connecting the second resilient member base section to the second resilient member angled section.

17. The battery receptacle system of claim 16 wherein the first resilient member further comprises a first resilient member end section connected to the first resilient member angled section with a second bend and the second resilient member further comprises a second resilient member end section connected to the second resilient member angled section with a second bend.

18. The battery receptacle system of claim 17 wherein the first resilient member comprises stainless steel and wherein the second resilient member comprises stainless steel.

19. The battery receptacle system of claim 14 further comprising:
a) a first lead coupled to the first contact and a second lead coupled to the second contact, wherein first and second leads couple to the first and second contacts in the terminal block and exit the terminal block through an opening defined by the base;
b) a waterproof seal surrounding the first and second leads where they exit the terminal block.

20. The battery receptacle of claim 19 wherein the adapter bracket comprises:
a) a planar mounting surface for abutting the first and second resilient members, wherein the mounting surface defines an opening sized to accept the first and second leads;
b) a housing surface configured to cooperate with a non-planar surface, wherein the housing surface defines an opening sized to accept the first and second leads; and
c) an adapter side wall connecting the mounting surface to the housing surface.
